(19) United States
(12) Patent Application Publication
(10) Pub. No.: US 2010/0165602 A1
(43) Pub. Date: Jul. 1, 2010

(54) LIGHTING APPARATUS, DISPLAY APPARATUS, AND TV RECEIVER

(75) Inventor: Yasumori Kuromizu, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/600,888

(22) PCT Filed: Jan. 22, 2008
(86) PCT No.: PCT/JP2008/050753

§ 371 Date: Nov. 19, 2009

(30) Foreign Application Priority Data
May 31, 2007 (JP) 2007-145440

(51) Int. Cl. G02F 1/13357

(52) U.S. Cl. 362/97.2; 362/97.1

(57) ABSTRACT

A lighting apparatus includes a back chassis covering a rear surface side thereof, a light source including a fluorescent tube having opposite end portions thereof held by the back chassis, and a supporting member mounted on the back chassis and arranged to support a portion of the light source between the opposite end portions thereof, wherein the supporting member is made of a shock-absorbing material capable of absorbing shock by its elastic behavior, and the light source is disposed on the supporting member.

### BACKGROUND OF THE INVENTION

1. Field of the Invention

The present invention relates to a lighting apparatus that illuminates a display panel such as a liquid crystal panel, and to a display apparatus and a television receiver including such a lighting apparatus.

2. Description of the Related Art

A conventional display apparatus is disclosed in JP-A-2005-347005 (see, for example, pages 4 to 9, and FIG. 2 of this reference). The display apparatus has a lighting apparatus that faces a display panel. In the lighting apparatus, there is provided a back chassis that is made of metal and covers the rear side separated from the display-panel side, and inside the back chassis, a light source is disposed.

FIG. 4 is a plan view showing how the light sources are supported inside the back chassis. Inside the back chassis 4, a plurality of light sources 5 are arranged and are defined by long florescent tubes. The back chassis 4 is provided with connecting portions 9 that feed electric power to the light sources 5, and opposite end portions of the light sources 5 are connected to the corresponding connecting portions 9 so as to be held in the back chassis 4.

Moreover, inside the back chassis 4, supporting members 10 are arranged so as to support portions of the light sources 5 between the opposite end portions thereof. FIG. 5 is a side view of the supporting members and the light sources 5. The supporting members 10 are each formed with a resin-molded article, and are each formed to have a ring-like shape that is opened at one portion thereof. The light sources 5 are sandwiched by the ring-like shaped supporting members 10 so as to maintain a constant distance from the back chassis 4. Thus, it is possible to illuminate the display panel 2 with uniform brightness. Moreover, it is possible to prevent breakage of the light source 5 caused by its colliding with the back chassis 4 or the adjacent light sources 5 when a shock acts on the lighting apparatus.

With the above-described conventional display apparatus, however, the light sources 5, at peripheries thereof, are surrounded by the ring-like shaped supporting members 10, and have an accordingly large area of contact with the supporting members 10. Thus, heat from the light sources 5 is dissipated through the supporting members 10.

FIG. 6 illustrates a relationship between temperature and brightness of the light sources 5 composed of fluorescent tubes. A vertical axis represents brightness, and a horizontal axis represents temperature. In FIG. 6, Ta indicates a temperature at point A (see FIG. 4) on the supporting member 10 of the light source 5, and Tb indicates a temperature at point B (see FIG. 4) spaced away from the supporting member 10. The light sources 5 are constructed so as to have their brightness vary with varying temperature, yielding the maximum brightness at the operating temperature (Tb). However, at point A on the supporting member 10 of the light source 5, heat is dissipated greatly, and the brightness is decreased accordingly. Consequently, a portion of the display panel corresponding to the supporting member 10 becomes dark, disadvantageously leading to a degraded quality of a display image.

Moreover, when a voltage is applied to the light sources 5 composed of fluorescent tubes, an electromagnetic force is generated to cause the light sources 5 to receive force in a Z direction. Consequently, the back chassis 4 is pressed and deformed via the supporting members 10. Accordingly, the back chassis 4 is vibrated by turning on and off the power of the light sources 5. When the display apparatus is increased in size, the voltage applied to the light sources 5 and hence the electromagnetic force are increased, disadvantageously causing the lighting apparatus therein to produce abnormal sounds due to the vibration.

Specifically, in a case where the back chassis 4 is made of metal, a capacitor is formed between the light sources 5 and the back chassis 4, permitting an electric current to pass through the back chassis 4. Consequently, the back chassis 4 receives the electromagnetic force, and is thus increasingly vibrated, with the result that the resulting abnormal sounds are made louder.

### SUMMARY OF THE INVENTION

Preferred embodiments of the present invention provide a lighting apparatus that shines light with uniform brightness, and that prevents generation of abnormal sounds, and also provide a display apparatus and a television receiver including such a lighting apparatus.

A lighting apparatus according to a preferred embodiment of the present invention includes: a back chassis arranged to cover a rear side of the lighting apparatus; a light source including a fluorescent tube extending in one direction in which opposite end portions are held by the back chassis; a supporting member fitted to the back chassis and arranged to support a portion of the light source between opposite end portions thereof, wherein the supporting member is made of a shock-absorbing material capable of absorbing shock by its elastic behavior, and the light source is disposed on the supporting member.

With this arrangement, the back chassis covers the rear side of the lighting apparatus, and holds the light source including a fluorescent tube at the opposite end portions thereof. The light source, with a voltage applied between the opposite end portions thereof, emits illumination light. Between the opposite end portions of the light source, the supporting member, fitted to the back chassis, is provided. The supporting member is preferably made of a shock-absorbing material such as resin or rubber, and is elastically deformed with the light source being disposed thereon, and supports a portion of the light source located between the opposite end portions thereof. When the light source, with a voltage applied thereto, receives the electromagnetic force so as to be deformed, the supporting member absorbs the deformation of the light source.

Moreover, according to a preferred embodiment of the present invention, in the lighting apparatus arranged as described above, the back chassis is preferably made of metal. With this arrangement, a capacitor is formed between the light source and the back chassis, permitting an electric current to pass through the back chassis with a voltage applied to the light source. When the back chassis receives the electromagnetic force as a result of the voltage application, the supporting member absorbs the deformation of the back chassis.

Moreover, according to a preferred embodiment of the present invention, in the lighting apparatus arranged as described above, the supporting member is preferably transparent, white/whitish or gray/grayish.

Moreover, according to a preferred embodiment of the present invention, in the lighting apparatus arranged as described above, the supporting member is preferably formed of a microcellular polymer. With this arrangement, the supporting member is preferably formed of a microcellular polymer, such as PORON (manufactured by Rogers Inoac Corporation), that serves as a shock-absorbing material.

Moreover, according to a preferred embodiment of the present invention, in the lighting apparatus arranged as described above, the supporting member is preferably formed of foamed polyethylene.

Moreover, according to a preferred embodiment of the present invention, in the lighting apparatus arranged as described above, the supporting member is preferably formed of rubber sponge.

Moreover, according to a preferred embodiment of the present invention, in the lighting apparatus arranged as described above, the supporting member is preferably formed of silicon-based gel.

A display apparatus according to a preferred embodiment of the present invention includes the lighting apparatus arranged as described above, and a display panel facing the light source.

Moreover, in the display apparatus arranged as described above, the display panel preferably is a liquid crystal panel including a pair of substrates with liquid crystal sealed therebetween.

A television receiver according to a preferred embodiment of the present invention includes the display apparatus arranged as described above.

According to a preferred embodiment of the present invention, the supporting member is arranged to support a portion of the light source between opposite end portions thereof and is preferably made of a shock-absorbing material, and the light source is disposed on the supporting member, helping reduce a contact area between the light source and the supporting member. This makes it possible to reduce the amount of heat dissipated from the light source via the supporting member, and to prevent a decrease in brightness in a portion of light source in contact with the supporting member. Thus, it is possible to illuminate the display panel with uniform brightness, and to achieve satisfactory display images.

Moreover, the deformation of the voltage-applied light source caused by the electromagnetic force is absorbed by the supporting member, and the vibration of the back chassis caused by turning on and off the applied voltage is prevented. This makes it possible to prevent the lighting apparatus from producing abnormal sounds.

Moreover, according to a preferred embodiment of the present invention, the back chassis is preferably made of metal. Thus, the vibration of the back chassis itself caused by the electromagnetic force in accordance with turning on and off of the applied voltage is absorbed by the supporting member, and the vibration of the back chassis is prevented. Thus, it is possible to prevent the lighting apparatus from producing abnormal sounds.

Moreover, according to a preferred embodiment of the present invention, the supporting member is preferably transparent, white/whitish or gray/grayish. Thus, it is possible to prevent degraded image quality caused by the supporting member reflected in the display panel.

Moreover, according to a preferred embodiment of the present invention, the supporting member is preferably formed of a microcellular polymer. Thus, it is possible to easily realize a supporting member capable of absorbing shock.

Moreover, according to a preferred embodiment of the present invention, the supporting member is preferably formed of foamed polyethylene. Thus, it is possible to easily realize a protective member capable of absorbing shock.

Moreover, according to a preferred embodiment of the present invention, the supporting member is preferably formed of rubber sponge. Thus, it is possible to easily realize a protective member capable of absorbing shock.

Moreover, according to a preferred embodiment of the present invention, the supporting member is preferably formed of silicon-based gel. Thus, it is possible to easily realize a protective member capable of absorbing shock.

Other features, elements, steps, characteristics and advantages of the present invention will become more apparent from the following detailed description of preferred embodiments of the present invention with reference to the attached drawings

### BRIEF DESCRIPTION OF THE DRAWINGS

FIG. 1 is a side sectional view of a display apparatus according to a preferred embodiment of the present invention.

FIG. 2 is a plan view showing how light sources are supported inside the display apparatus according to a preferred embodiment of the present invention.

FIG. 3 is a side view specifically showing how the light sources are supported inside the display apparatus according to a preferred embodiment of the present invention.

FIG. 4 is a plan view showing how the how light sources are supported inside a conventional display apparatus.

FIG. 5 is a side view showing how the light sources are supported inside the conventional display apparatus.

FIG. 6 is a graph representing a relationship between temperature and brightness of the light sources.

### DETAILED DESCRIPTION OF THE PREFERRED EMBODIMENTS

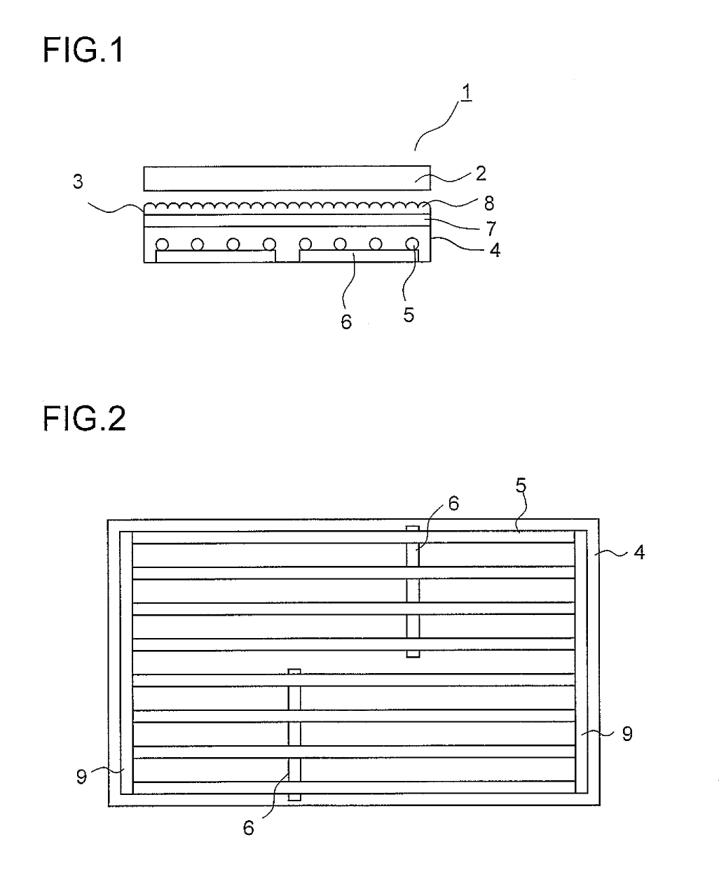

Hereinafter, preferred embodiments of the present invention will be described with reference to the accompanying drawings. FIG. 1 is a side sectional view of a display apparatus according to a preferred embodiment of the present invention. A display apparatus 1, such as a television receiver or a display, has a lighting apparatus 3 arranged at the back of a display panel 2 such as a liquid crystal panel. The display panel 2 preferably includes a liquid crystal panel or the like that has a pair of substrates with liquid crystal sealed therebetween. The display panel 2 has pixels arranged in a matrix, and the light emitted from the lighting apparatus 3 transmits a predetermined pixel of the display panel 3 so that images are displayed.

The lighting apparatus 3 is provided with a back chassis 4, preferably formed of metal, which covers the rear side of the lighting apparatus 3. By forming the back chassis 4 of metal, it is possible to obtain desired strength with a decreased thickness thereof, and thus to achieve a compact lighting apparatus. Inside the back chassis 4, light sources 5 are disposed. The light sources 5 preferably are a plurality of cylindrical florescent tubes that are arranged at a predetermined interval. The light source 5 may be formed with a meandering florescent tube, for example.

On the back chassis 4, a diffusion plate 7 that faces the light sources 5 is disposed. The diffusion plate 7 is preferably formed of plate-shaped transmissive member holding a diffusion member, and diffuses light emitted from the light sources 5. On the diffusion plate 7, an optical sheet 8, such as a prism sheet or a lens sheet, is arranged. The optical sheet 8 focuses the light emitted from the diffusion plate 7 in a range of a predetermined angle of view.

FIG. 2 is a plan view showing how light sources as the light source 5 are supported inside the back chassis 4. At opposite side portions of the back chassis 4, connecting portions 9 that hold opposite ends of the light sources 5 to feed electric power to them are arranged. By the connecting portions 9, the light sources 5 are held in the back chassis 4. In addition, the back chassis 4 has supporting members 6 laid on the back chassis 4, and on the supporting members 6, the light sources 5 are placed.

The supporting members 6 are preferably formed of a shock-absorbing material capable of absorbing shock by its elastic behavior, thus making it possible to use resin, rubber or other suitable material that is spongy or has cushioning properties. For example, for the supporting members 6, it is possible to use foamed polyethylene, rubber sponge, silicon-based gel, or other suitable material. Preferably, for the supporting members 6, microcellular polymer (for example, PORON manufactured by Rogers Inoac Corporation) is used, since it offers a high shock absorbing performance.

The supporting members 6 are preferably transparent, white/whitish, or gray/grayish. In this way, it is possible to prevent degraded image quality caused by the supporting members 6 reflected in the display panel 2. Note that white/whitish includes not only white but also pale yellow etc.; gray/grayish includes pale gray and dark gray.

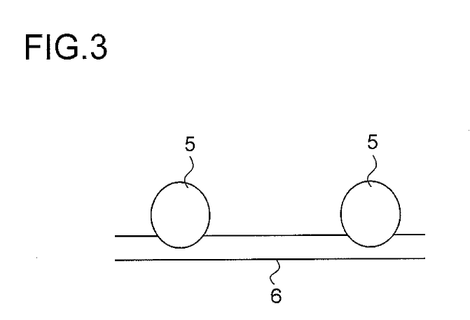

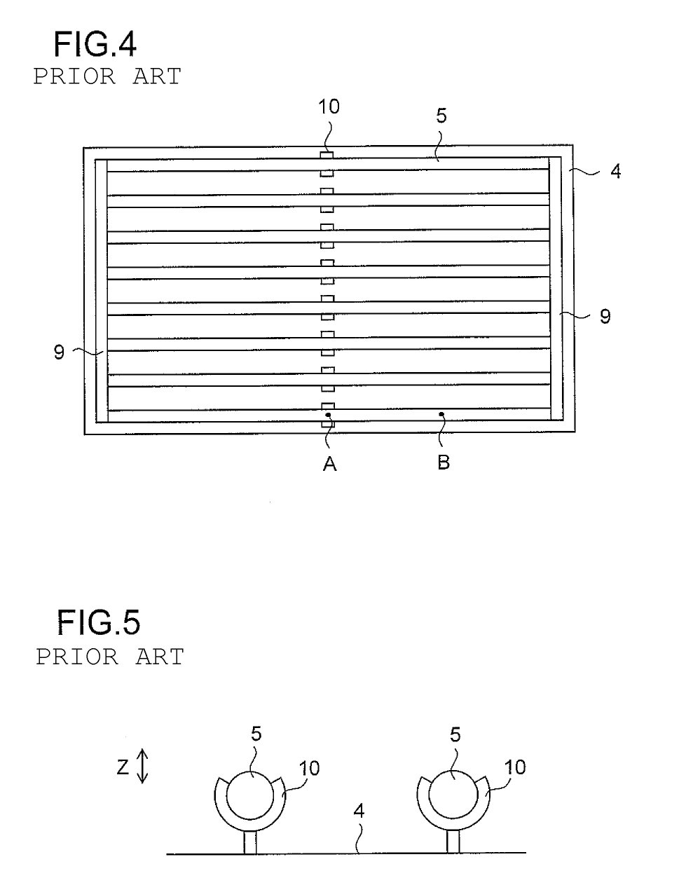

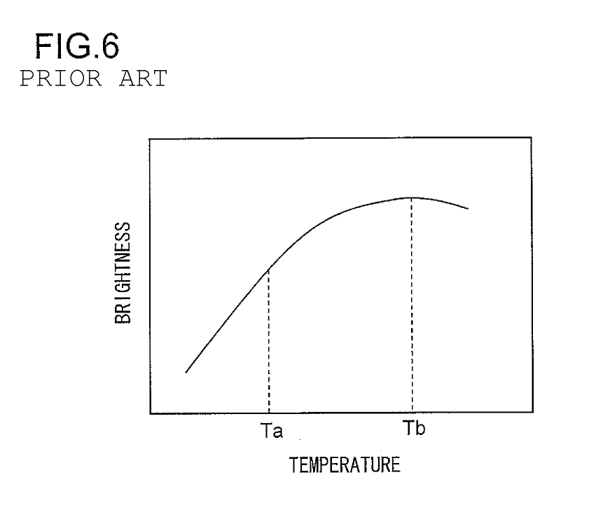

FIG. 3 is a side view specifically showing how the light sources 5 are supported by the supporting members 6. The light sources 5 are connected to the connecting portions 9 with the light sources 5 pressing the supporting members 6 and the supporting members 6 being contracted. As a result, the light sources 5 each have a portion of a circumferential surface thereof, which is smaller than half the circumference thereof, in contact with the supporting member 6, and a portion of the light source 5 between the opposite end portions is thus supported by the supporting members 6.

Consequently, movement of the light sources 5 toward the back chassis 4 is prevented by the elastic behavior of the supporting members 6, and that towards the adjacent light sources 5 is prevented by the frictional force of the supporting members 6. Moreover, when shock acts on the display apparatus 1, the shock forces are absorbed by the supporting members 6. Accordingly, it is possible to prevent deflection of the light sources 5 caused by their weight, and to prevent breakage of the light sources 5 caused by its colliding with the back chassis 4 due to shock, etc., during transportation. The supporting members 6 may support a plurality of portions of the light sources 5, or one place in center portions of the light sources 5.

In the display apparatus 1 arranged as described above, light emitted from the light sources 5 enters the diffusion plate 7. The light incident on the diffusion plate 7 is diffused, and the light so diffused enters the optical sheet 8. The light incident on the optical sheet 8 has its advancing direction adjusted to be in a desired range of view angle, and is emitted therefrom to irradiate the display panel 2. This enables images on the display panel 2 to be visually recognized.

According to this preferred embodiment, the supporting member 6 supporting the portion between the opposite end portions of the light sources 5 is preferably made of a shock-absorbing material, and the light sources 5 are placed on the supporting member 6, helping reduce a contact area between the light source 5 and the supporting member 6. Thus, the mount of heat dissipated from the light sources 5 via the supporting member 6 is reduced, and thereby a drop in brightness in portions of the light sources 5 in contact with the supporting members 6 can be prevented. This makes it possible to illuminate the display panel 2 with uniform brightness, and thus to achieve satisfactory display images.

Moreover, the light sources 5, to which a voltage is applied, are deformed with the electromagnetic force acting in a direction (Z direction, see FIG. 5) perpendicular or substantially perpendicular to the back chassis 4. Such deformation of the light sources 5 caused by the electromagnetic force is absorbed by the supporting member 6. Thus, vibration of the back chassis caused by turning on and off the applied voltage via the supporting member 6 is prevented. Thus, it is possible to prevent the lighting apparatus 3 from producing abnormal sounds.

Moreover, the back chassis 4 is made of metal, and thus a capacitor is formed between the light sources 5 and the back chassis 4, permitting an electric current to pass through the back chassis 4 with the voltage applied to the light sources 5. Owing to the electromagnetic force, the back chassis 4 itself is vibrated in accordance with on and off of the applied voltage; however, the vibration so produced is also absorbed by the supporting member 6. Thus, it is possible to further prevent the lighting apparatus 3 from producing abnormal sounds.

Preferred embodiments of the present invention are applicable to a lighting apparatus illuminating a display panel such as a liquid crystal panel, and to a display apparatus, such as a television receiver and a display, using the same.

While preferred embodiments of the present invention have been described above, it is to be understood that variations and modifications will be apparent to those skilled in the art without departing the scope and spirit of the present invention. The scope of the present invention, therefore, is to be determined solely by the following claims

1-10. (canceled)

11. A lighting apparatus comprising:
a back chassis arranged to cover a rear side of the lighting apparatus;
a light source including a fluorescent tube and arranged such that opposite end portions thereof are held by the back chassis;
a supporting member fitted to the back chassis and arranged to support a portion of the light source between the opposite end portions thereof; wherein
the supporting member is made of a shock-absorbing material capable of absorbing shock by an elastic behavior thereof; and
the light source is disposed on the supporting member.

12. The lighting apparatus according to claim 11, wherein the back chassis is made of metal.

13. The lighting apparatus according to claim 11, wherein the supporting member is transparent, white/whitish, or gray/grayish.

14. The lighting apparatus according to claim 11, wherein the supporting member is made of a microcellular polymer material.

15. The lighting apparatus according to claim 11, wherein the supporting member is made of a foamed polyethylene material.

16. The lighting apparatus according to claim 11, wherein the supporting member is made of a rubber sponge material.

17. The lighting apparatus according to claim 11, wherein the supporting member is made of a silicon-based gel.

18. A display apparatus comprising the lighting apparatus according to claim 11, and a display panel facing the light source.

19. The display apparatus according to claim 18, wherein the display panel is a liquid crystal panel including a pair of substrates with liquid crystal sealed therebetween.

20. A television receiver comprising the display apparatus according to claim 18.
